(19) United States
(12) Patent Application Publication
(10) Pub. No.: US 2013/0090432 A1
(43) Pub. Date: Apr. 11, 2013

(54) ALKOXYLATED POLYMERS

(71) Applicants: Andreas Kunst, Ludwigshafen (DE); Daniel Freidank, Lemfoerde (DE); Marco A. Villalobos, Brighton, MA (US)

(72) Inventors: Andreas Kunst, Ludwigshafen (DE); Daniel Freidank, Lemfoerde (DE); Marco A. Villalobos, Brighton, MA (US)

(73) Assignee: BASF SE, Ludwigshafen (DE)

(21) Appl. No.: 13/497,277

(22) PCT Filed: Sep. 29, 2010
(86) PCT No.: PCT/EP10/64388

§ 371 Date: Mar. 21, 2012

Related U.S. Application Data
(60) Provisional application No. 61/246,992, filed on Sep. 30, 2009.

(51) Int. Cl. C08F 220/28; C08G 18/62; C08F 8/02

(52) U.S. Cl. CPC C08F 220/28; C08F 8/02; C08G 18/6258; C08G 18/6229
USPC 525/123; 525/330.3; 525/329.7

(57) ABSTRACT

A process for the preparation of alkoxylated polymers comprising the steps (i) preparation of a polymeric product (I) having at least one functional group by radical copolymerization in a high temperature polymerization process and (ii) contacting the polymeric product (I) having at least one functional group obtained in step (i) with at least one alkylene oxide; an alkoxylated polymer obtainable by the process of the present invention; a process for preparing polyurethanes by reaction of the alkoxylated polymer according to the present invention; polyurethane prepared by the process of the present invention; surface active reagents comprising or consisting of the alkoxylated polymer according to the present invention as well as detergent formulations comprising at least one alkoxylated polymer according to the present invention.

The present invention relates to a process for the preparation of alkoxylated polymers comprising the steps (i) preparation of a polymeric product (I) having at least one functional group by radical copolymerization in a high temperature polymerization process and (ii) contacting the polymeric product (I) having at least one functional group obtained in step (i) with at least one alkylene oxide, an alkoxylated polymer obtainable by the process of the present invention, a process for preparing polyurethanes by reaction of the alkoxylated polymer according to the present invention, polyurethane prepared by the process of the present invention, surface active reagents comprising or consisting of the alkoxylated polymer according to the present invention as well as detergent formulations comprising at least one alkoxylated polymer according to the present invention.

Alkoxylated polymers are useful for several different applications. They may be used for the preparation of polyurethanes by reaction of isocyanates as well as for surface active reagents, for example non-ionic surfactants, electrosteric surfactants, protective colloids, superabsorbers, dispersants, surface modification agents, plastic modifiers and concrete plasticizers as well as steric stabilizers for polymer-filled polyols or in detergent mixtures.

In DE 31 31 848 A1, a process for the preparation of block copolymers having at least one hydroxy functional group is disclosed. The block copolymers consist of polymeric blocks of acrylates and/or methacrylates and polymeric blocks of poly(alkylene) oxides. The block copolymers with at least one hydroxy functional group containing polymeric blocks from acrylate and/or methacrylate are prepared by a radical polymerization process known in the art, preferably in the presence of a regulator comprising a mercapto group to obtain liquid acrylate and/or methacrylate copolymers.

It is known in the art that the selection of comonomers is limited in the conventional radical copolymerization process used according to DE 31 31 848 A for obtaining the block copolymers with at least one hydroxy functional group. Only comonomers having the same or a nearly the same copolymerization parameter could be used together in order to get a block copolymer with a statistical backbone. If comonomers having different reactivity are used for the preparation of the block copolymers, long sequences of polymeric blocks of the most reactive monomers will be obtained which leads to a broad composition distribution in the block copolymers prepared by conventional radical copolymerization processes. At low molecular weight, this results in a sizable low oligomer population with a highly heterogeneous copolymer composition. Clearly, such heterogeneity of the functionalized block copolymers obtained by conventional radical copolymerization processes leads to problems in preparing polyalkoxylated grafts, particularly when non-functional low molecular weight oligomers are present, which cannot initiate an alkoxylation reaction. The graft product obtained by using a functionalized polymeric backbone prepared by a conventional radical copolymerization process, therefore leads to an inhomogeneous product, which is not desired.

Further, the conventional radical copolymerization process is limited in view of the functionalized monomers used to obtain the functionalized block copolymers. The hydroxy group in the block copolymer backbone has to be prepared starting from costly hydroxyalkyl(meth)acrylates.

It is therefore an object of the present invention to provide alkoxylated polymers which are homogeneous products having a high content of functional groups even at low molecular weights and also having a narrow molecular weight distribution and a narrow composition distribution.

The object is solved by a process for the preparation of alkoxylated polymers comprising the steps
(i) preparation of a polymeric product (I) having at least one functional group by radical copolymerization of the following monomers
   (a) at least one functionalized acrylic monomer (a);
   (b) at least one additional monoethylenically unsaturated free radical polymerizable monomer (b); and
   (c) optionally at least one multiethylenically unsaturated free radical polymerizable monomer (c)
   at temperatures between 150 and 350° C.;
(ii) contacting the polymeric product (I) having at least one functional group obtained in step (i) with at least one alkylene oxide.

It has been found that superior alkoxylated polymers are obtained in the process of the present invention, wherein the polymeric product (I) having at least one functional group is prepared by a high temperature polymerization process. One advantage is related to the fact that at higher temperatures even ethylenically unsaturated monomers having low reactivities such as α-olefins having 8 to 22 carbon atoms, α,β- and β,β-disubstituted vinyl monomers as well as cyclic monomers such as cyclopentadiene can be copolymerised with monomers usually employed such as (meth)acrylates and styrenics independently of their reactivity ratio to obtain the desired polymeric product (I) having at least one functional group in high yields. A further advantage is that a high amount of functional groups can be incorporated into the polymeric product (I) even at low molecular weights. Further, the polymers obtained in the high temperature polymerization process according to step (i) of the present invention have narrow molecular weight distributions as well as narrow composition distributions even at low molecular weights, thus enhancing the homogeneity of the desired alkoxylated polymers. One further advantage is that the alkoxylation reaction (step (ii)) can be carried out in the same reaction train after or simultaneously with the preparation of the product (I) in step (i) thus taking advantage of the low viscosity and high reactivity of the polymeric product (I) obtained in step (i) at elevated temperatures and thereby minimizing the reaction time and the reaction energy requirements. However, it is also possible to carry out steps (i) and (ii) of the process of the present invention in separate reaction trains.

### Step (i) Preparation of a Polymeric Product (I)

The polymeric product (I) having at least one functional group is prepared by radical copolymerization of the following monomers
(a) at least one functionalized acrylic monomer (a);
(b) at least one additional monoethylenically unsaturated free radical polymerizable monomer (b); and
(c) optionally, at least one multiethylenically unsaturated free radical polymerizable monomer (c).

The radical copolymerization of the monomers (a), (b) and optionally (c) is carried out in a high temperature polymerization process at temperatures between 150 and 350° C. The advantages of the high temperature polymerization process for the preparation of the desired alkoxylated polymers have been discussed before.

Preferably, the high temperature polymerization process according to step (i) of the present invention is carried out at reaction temperatures of from 160° C. to 275° C., more preferably from 170° C. to 260° C. and most preferably from 180° C. to 250° C.

The reaction time in step (i) of the process of the present invention is in general of from 1 to 90 minutes, preferably from 5 to 25 minutes, and more preferably from 10 to 15 minutes. The reaction may be carried out in a continuous process, a batch process or a semi-continuous process. In a continuous process, the term reaction time means the residence time.

The reaction may be carried out in the presence or in the absence of solvents. The amount of solvents is in general of from 0 to 30% by weight, preferably from 0 to 15% by weight, based on the total amount of the monomers used.

Suitable solvents are all liquids which are inert toward the reactants, i.e. for example ethers such as ethylene glycol ether, esters such as butyl acetate, and ketones such as methylamylketone. Further suitable solvents are toluene, xylenes, cumene and heavier aromatic solvents (such as Aromatic 100, Aromatic 150 from Exxon), particular cumene and m-xylene, and aliphatic alcohols such as isopropanol.

If monomers or solvents with boiling points below the reaction temperature are present, the reaction should advantageously be carried out under pressure, preferably under the autogenous pressure of the system.

The amount of solvents is general of from 0 to 30% by weight, preferably of from 0 to 15% by weight, based on the total amount of all components used in the polymerization mixture in step (i).

It is generally advisable to carry the conversion of the polymerization to 50 to 99 mol %, preferably 80 to 95 mol %, since narrow molecular weight distributions are obtained in this way. Unconverted monomers and volatile oligomers and the solvent which may be used are advantageously recycled to the polymerization after conventional separation from the polymer by flash evaporation or distillation.

The polymerization in step (i) of the present invention is usually carried out in the presence of one or more polymerization initiators. Suitable polymerization initiators are compounds which form free radicals and whose decomposition temperature is in the range of from 150 to 350° C. Examples for suitable polymerization initiators are ditertbutylperoxide, diteramylperoxide, and dibenzoylperoxide.

The amount of the initiators is preferably in the range of from 0.1 to 5% by weight, preferably 0.2 to 3% by weight, based on the total amount of monomers used in the polymerization in step (i).

The polymerization in step (i) may be carried out in any suitable polymerization reactor system known in the art. Suitable reactor systems are, for example, continuously stirred tank reactors (CSTR), tubular reactors optionally fitted with static mixers, loop reactors and annular thin-film reactors, optionally having a recycling means. They are optionally equipped with an apparatus by means of which some of the product can be recycled to the reactor entrance. Since the exothermic polymerization can be carried out under substantially isothermal conditions suitable heat removal capability must be ensured.

Suitable reaction conditions for the preparation of the polymeric products (I) by a high temperature polymerization process are, for example, described in U.S. Pat. No. 6,552,144 and U.S. Pat. No. 6,605,681.

The polymeric product (I) obtained in step (i) of the process of the present invention in general has a weight average molecular weight M_{w} of from 1,000 to 30,000 g/mol, preferably 1,500 to 25,000 g/mol and more preferably 2,000 to 20,000 g/mol.

With the process according to step (i) of the process of the present invention it is possible to prepare polymeric products (I) having at least one functional group which are liquid or solid, depending on the polymerization conditions as well as on the monomers employed.

Preferred solid polymeric products (I) have molecular weights of from 3,000 to 20,000 g/mol. Preferred liquid polymeric products (I) have molecular weights of from 1,500 to 4,500 g/mol.

### Monomer (a)

Monomer (a) employed in step (i) of the process according to the present invention is at least one functionalized acrylic monomer (a). The monomer employed may preferably be functionalized with OH, COOH, epoxy, NH, NH₂, cyclic anhydride and/or SH groups resulting in a polymeric product (I) having at least one functional group selected from the groups consisting of OH, COOH, NH, NH₂, cyclic anhydride and SH. Suitable acrylic monomers are known in the art. More preferably, the at least one functionalized acrylic monomer (a) is selected from the group consisting of OH-functional acrylic monomers (a1), COOH-functional acrylic monomers (a2), cyclic anhydride monomers (a3) and epoxy-functional acrylic monomers (a4) and mixtures thereof.

Examples of OH-functional acrylic monomers (a1)) include both acrylates and methacrylates. Suitable examples are those containing primary or secondary hydroxy groups such as 2-hydroxyethylacrylate (HEA), 2-hydroxyethylmethacrylate (HEMA), 2-hydroxypropylacrylate (2-HPA), 3-hydroxypropylacrylate (3-HPA), 2-hydroxypropylmethacrylate (2-HPMA), 3-hydroxypropylmethacrylate (3-HPMA), 2-hydroxybutylacrylate (2-HBA), 4-hydroxybutylacrylate (4-HBA), 2-hydroxybutylmethacrylate (2-HBMA) and/or 4-hydroxybutylmethacrylate (4-HBMA).

Preferred OH-functional acrylic monomers are 2-hydroxyethylacrylate (HEA) and 2-hydroxyethylmethacrylate (HEMA).

Further OH-functional monomers are functionalized vinylic, allyl or methallyl ether monomers of dihydric or more alcohols.

Suitable vinylic ether monomers are for example hydroxybutylvinylether (HBVE), hydroxybutylallylether, mono- or divinylether of glycerin, mono- or divinylether of trimethylolpropane, mono-, di-, or trivinylether of pentaerythritol or mixtures thereof, whereby hydroxybutylvinylether is preferred.

Suitable allyl or methallyl ether monomers are for example 2-hydroxyethylallylether, 2-hydroxyethylmethallylether, 2-hydroxypropylallylether, 2-hydroxypropylmethallylether, 3-hydroxypropylallylether, 3-hydroxypropylmethallylether, 2-hydroxybutylallylether, 2-hydroxybutylmetallylether, 4-hydroxybutylallylether, 4-hydroxybutylmethallylether, mono- or diallylether or mono- or dimethallylether of glycerin, mono- or diallylether or mono- or dimethallylether of trimethylolpropane, mono-, di-, or triallylether or mono-, di, or trimethallylether of pentaerythritol or mixtures thereof.

Suitable COOH-functional acrylic monomers (a2) are preferably selected from acrylic acid, methacrylic acid and mixtures thereof, whereby acrylic acid is preferred.

Suitable acidic anhydride monomers (a3) are preferably selected from succinic anhydride, maleic anhydride, methylmaleic anhydride, dimethylmaleic anhydride and mixtures thereof, whereby maleic anhydride is preferred.

Examples of suitable epoxy-functional acrylic monomers (a4) include both acrylates and methacrylates, for example, those containing 1,2 expoxy groups such as glycidyl acrylate and glycidyl methacrylate and mixtures thereof. A preferred epoxy-functional acrylic monomer is glycidyl methacrylate.

The at least one functionalized acrylic monomer (a) is selected depending on the desired functionality of the polymeric product (I). In the case that the polymeric product (I) comprises OH functionalities, hydroxyethyl methacrylate and/or hydroxyethyl acrylate are preferably employed as monomer (a1).

In the case that the polymeric product (I) comprises a COOH functionality, the monomers (a) are preferably monomers (a2), more preferably acrylic acid and/or methacrylic acid. The direct alkoxylation (step (ii)) according to the process of the present invention of COOH backbones is not known in the prior art. It has been found that copolymeric backbones that contain COOH functional groups (polymeric products (I) having at least one COOH functional group) can directly react with at least one alkylene oxide in step (ii) according to the present invention in the presence or even without a suitable catalyst without the need of transferring the COOH group into ester derivatives. Therefore, the production costs for the production of alkoxylated polymers starting from polymeric product (I) having at least one COOH functional group can be significantly reduced and the overall process can be simplified.

### Monomer (b)

Monomer (b) is at least one monoethylenically unsaturated free radical polymerizable monomer, which is different from the monomers (a). Preferred monomers (b) are selected from the group consisting of
(b1) esters of α,β-monoethylenically unsaturated monocarboxylic or dicarboxylic acids having 3 to 6 carbon atoms with alkanols having 1 to 20 carbon atoms (b1),
(b2) vinyl aromatic monomers (b2),
(b3) esters of vinyl alcohol and monocarboxylic acids having from 1 to 18 carbon atoms (b3),
(b4) olefins (b4),
(b5) nitriles of α,β-monoethylenically unsaturated monocarboxylic acids having 1 to 18 carbon atoms (b5), and
(b6) C₄-C₈-conjugated dienes (b6)
   or mixtures of the monomers mentioned before.

Suitable esters of α,β-monoethylenically unsaturated monocarboxylic or dicarboxylic acids having 3 to 6 carbon atoms with alkanols having 1 to 20 carbon atoms (b1) are preferably esters of acrylic acid, methacrylic acid, maleic acid, fumaric acid or itaconic acid with alkanols having preferably from 1 to 12, more preferably 1 to 8 and most preferably 1 to 4 carbon atoms, wherein the esters are preferably non-functional acrylates or non-functional methacrylates such as methyl acrylate, methyl methacrylate, ethyl acrylate, ethyl methacrylate, propyl acrylate, propyl methacrylate, isopropyl acrylate, isopropyl methacrylate, n-butyl acrylate, n-butyl methacrylate, isobutyl acrylate, isobutyl methacrylate, tert-butyl acrylate, tert-butyl methacrylate and 2-ethylhexyl acrylate and 2-ethylhexyl methacrylate, octyl acrylate, octyl methacrylate and mixtures thereof. Further, suitable esters of α,β-monethylenically dicarboxylic acids are dimethyl maleate and n-butyl maleate.

Further suitable monomers (b1) are the non-functional acrylate monomers mentioned in U.S. Pat. No. 6,552,144 B1 which is incorporated by reference.

Preferred monomers (b1) are butyl acrylate, 2-ethylhexyl acrylate and methyl methacrylate.

Suitable vinyl aromatic monomers (b2) are, for example, styrene, 2-vinyl naphthaline, 9-vinyl anthracene, substituted vinyl aromatic monomers such as p-methylstyrene, amethylstyrene, t-butylstyrene, o-chlorostyrene, p-chlorostyrene, 2,4-dimethylstyrene, 4-vinyl-biphenyl, vinyl toluene, vinyl pyridine and mixtures thereof.

A preferred vinyl aromatic monomer (b2) is styrene.

Suitable esters of vinyl alcohols and monocarboxylic acids having from 1 to 18 carbon atoms (b3) are, for example, vinyl acetate, vinyl propionate, vinyl n-butyrate, vinyl laureate and vinyl stearate.

Suitable olefins (b4) are, for example, C₂ to C₂₀ olefins such as ethylene, propylene or C₈ to C₂₀ alpha olefins such as octene-1, decene-1 or mixtures thereof, preferably C₈ to C₁₄ alpha olefins.

Suitable nitriles of α,β-monoethylenically unsaturated monocarboxylic acids having from 1 to 18 carbon atoms (b5) are, for example, acrylonitrile and methacrylonitrile.

Suitable C₄-C₈-conjugated dienes (b6) are, for example, 1,3-butadiene or isoprene.

In a preferred embodiment of the present invention the at least one monoethylenically unsaturated free radical polymerizable monomer (b) is selected from at least one element of the group consisting of the monomers mentioned under (b1) and (b2). Even more preferably, the monomer (b) is selected from at least one element of the group consisting of C₁-C₈ alkyl acrylate, C₁-C₈ alkyl methacrylate, especially n-butyl acrylate, 2-ethyl hexyl acrylate or methyl methacrylate as monomer (b1) and styrene, α-methyl styrene or vinyl toluene, especially styrene as monomer (b2).

The monomers (b) are selected depending on the desired polymeric product (I), as known by a person skilled in the art. In the case that the desired polymeric product (I) is a solid product, preferred monomers (b) are, for example, methyl methacrylate as monomer (b1) and styrene as monomer (b2). In the case that the polymeric product (I) is a liquid polymer, the monomers (b) are preferably n-butyl acrylate and/or 2-ethyl hexyl acrylate as monomer (b1).

### Branched or Hyperbranched Polymeric Products (I)

In one embodiment of the present invention a process is provided for the preparation of branched or hyperbranched polymeric products (I) which are subsequently contacted with at least one alkylene oxide in step (ii) according to the process of the present invention. There are several routes to achieve a branching or hyperbranching of the polymeric product (I) in step (i) of the process of the present invention. Suitable routes are, for example:
(ia) using at least one multiethylenically unsaturated free radical polymerizable monomer (c) during the synthesis of the polymeric product (I) having at least one functional group, as, for example, shown in U.S. Pat. No. 6,265,511. Suitable multiethylenically unsaturated free radical polymerizable monomers (c) are mentioned below;
(ib) using multifunctional condensation co-reactants (such as polyamines, polyapoxides, polyacids) during or after the synthesis of the polymeric product (I) having at least one functional group as shown, for example, in U.S. Pat. No. 6,346,590 and WO 00/218456. Suitable polyamines, polyepoxides and polyacids are mentioned in said documents and known by a person skilled in the art;
(ic) using multifunctional condensation co-reactants such as polyamines or polyacids during or after the alkoxylation reaction (step ii) of the process of the present invention to react the terminal OH group of the polyalkoxylates as disclosed, for example, in WO 00/218456.

The final alkoxylated polymers obtained after step (ii) of the process of the present invention obtained by carrying out route (ia) or (ib) are branched polymers having free OH groups based on the polyalkoxylate polymer-filled obtained in step (ii) according to the process of the present invention. According to route (ic), branched alkoxylated polymers are obtained crosslinked to the polyalkoxylated chains obtained in step (ii) according to the process of the present invention.

### Monomers (c)

As mentioned before, branched or hyperbranched polymeric products (i) having at least one functional group may be obtained according to step (ia) by polymerization monomers (a) and (b) in the presence of at least one multiethylenically unsaturated free radial polymerizable monomer (c). Such multiethylenically unsaturated free radial polymerizable monomers (c) preferably comprise at least two non-conjugated double bonds and are, for example, selected from the group consisting of alkylene glycol diacrylate and alkylene glycol dimethacrylate such as ethylene glycol diacrylate, 1,2-propylene glycol diacrylate, 1,3-propylene glycol diacrylate, 1,3-butylene glycol diacrylate, 1,4-butylene glycol diacrylate, ethylene gycol dimethacrylate, 1,2-propylene glycol dimethacrylate, 1,3-propylene glycol dimethacrylate, 1,3-butylene glycol dimethacrylate and 1,4-butylene glycol dimethacrylate; divinyl benzene, vinyl methacrylate, vinyl acrylate, allyl methacrylate, allyl acrylate, diallyl maleate, diallyl fumarate, methylene bisacrylamide, cyclopentadienyl acrylate, triallyl cyanurate, triallyl isocyanurate as well as diacetone acrylamide, acetylacetoxyethyl acrylate and acetylacetoxyethyl methacrylate as well as mixtures thereof. More preferably, alkylene glycol diacrylate, alkylene glycol dimethacrylate, especially the alkylene glycol diacrylates and alkylene glycol dimethacrylates mentioned before and/or divinyl benzene are employed as monomers (c).

In a preferred embodiment of the present invention the following monomers (a), (b) and optionally (c) are radically copolymerized
(a) at least one functionalized acrylic monomer (a) is selected from the group consisting of OH-functional acrylic monomers (a1), COOH-functional acrylic monomers (a2), cyclic anhydride monomers (a3) and epoxy-functional acrylic monomers (a4) and mixtures thereof;
(b) at least one additional monoethylenically unsaturated free radical polymerizable monomer (b) selected from at least one element of the group consisting of
   (b1) esters of α,β-monoethylenically unsaturated monocarboxylic or dicarboxylic acids having 3 to 6 carbon atoms with alkanols having 1 to 20 carbon atoms (b1),
   (b2) vinyl aromatic monomers (b2),
   (b3) esters of vinyl alcohol and monocarboxylic acids having from 1 to 18 carbon atoms (b3),
   (b4) olefins (b4),
   (b5) nitriles of α,β-monoethylenically unsaturated monocarboxylic acids having 1 to 18 carbon atoms (b5), and
   (b6) C₄-C₈-conjugated dienes (b6) or mixtures of the monomers mentioned before; and
(c) optionally at least one multiethylenically unsaturated free radical polymerizable monomer (c) comprising at least two non-conjugated double bonds selected from the group consisting of alkylene glycol diacrylate, alkylene glycol dimethacrylate, divinyl benzene, vinyl methacrylate, vinyl acrylate, allyl methacrylate, allyl acrylate, diallyl maleate, diallyl fumarate, methylen bisacrylic amide, cyclopentadianyl acrylate, triallyl cyanurate, trialllyl isocyanurate, diacetone acrylic amide, acetylacetoxyethyl acrylate and acetylacetoxyethyl methacrylate.

The at least one functionalized acrylic monomer (a) is usually employed in the radical copolymerization in step (i) of the present invention in an amount of from 5 to 70% by weight, preferably 10 to 65% by weight, more preferably 15 to 60% by weight and most preferably 20 to 50% by weight, based on the total amount of monomers (a), (b) and optionally (c) employed. It is one important advantage of the high temperature polymerization according to step (i) of the present invention that high content of functional groups can be incorporated into the polymeric product (I) even at low molecular weights.

The at least one additional monoethylenically unsaturated free radical polymerizable monomer (b) is in general employed in an amount of from 30 to 95% by weight, preferably 35 to 90% by weight, more preferably 40 to 85% by weight and most preferably 50 to 80% by weight, based on the total amount of monomers (a), (b) and optionally (c) employed.

The optionally employed at least one multiethylenically unsaturated free radical polymerizable monomer (c) is generally employed in an amount of from 0 to 15% by weight, preferably 0.1 to 12% by weight, more preferably 0.5 to 10% by weight and most preferably 1 to 4% by weight, based on the total amount of monomers (a), (b) and (c) employed.

In a preferred embodiment of the present invention, a process is disclosed wherein in step (i)
(a) 5 to 70% by weight, preferably 10 to 65% by weight, more preferably 15 to 60% by weight and most preferably 20 to 50% by weight of at least one monomer (a),
(b) 30 to 95% by weight, preferably 35 to 90% by weight, more preferably 40 to 85% by weight and most preferably 50 to 80% by weight of at least one monomer (b), and
(c) 0 to 15% by weight, preferably 0.1 to 12% by weight, more preferably 0.5 to 10% by weight and most preferably 1 to 4% by weight of at least one monomer (c),
   wherein the sum of the monomers (a), (b) and optionally (c) is 100% by weight, are radically copolymerized.

Suitable monomers (a), (b) and (c) are mentioned before.

It is an advantage of the high temperature polymerization process according to step (i) that the polymeric product (I) having at least one functional group has a narrow molecular weight distribution as well as a narrow composition distribution, thus enhancing the homogeneity of the desired alkoxylated polymers obtained in step (ii) of the present invention. The polymeric product (I) having at least one functional group obtained in step (i) is therefore in one preferred embodiment a perfectly statistical copolymer, preferably having a molecular weight distribution M_{w}/Mₙ of at most 4.0, more preferably 1.5 to 3.0 and most preferably 1.5 to 2.5.

### Step (ii)

In step (ii) of the present invention, the polymeric product (I) having at least one functional group obtained in step (i) is contacted with at least one alkylene oxide.

As mentioned before, because process step (i) is carried out as a high temperature polymerization process a high content of functional groups can be incorporated into the polymeric product (I) even at low molecular weight and polymeric products (I) having a narrow molecular weight distribution and a narrow composition distribution are obtained. This is important to obtain very homogenous alkoxylated polymers in step (ii) of the present invention. Alkylene oxide side chains obtained in step (ii) can be tailored separately from the polymeric products (I) obtained according to step (i) of the process of the present invention by providing side chains with different compositions, microstructures and molecular weight characteristics than the polymeric product (I). The combination of steps (i) and (ii) according to the process of the present invention allows therefore for separate tailoring of molecular characteristics of the polymeric product (I) (backbone) and the alkylene oxide side chains. The polymeric product (I) and the alkylene oxide side chains may be different in their solubility parameters, glass transition temperatures, chemical functionalities, average molecular weights, and so on, thus allowing for a high degree of molecular design and ultimately properly tailoring and control.

As examples showing the range of applicability of the alkoxylated polymers according to the present invention obtained in the process of the present invention, it may be considered that polymeric products (I) (backbones) having a low glass transition temperature (T_{g}) and alkoxylate side chains having a low glass transition temperature (T_{g}) may lead to alkoxylated polymers which may be liquid bearing liable functional groups and having a low viscosity. Such alkoxylated polymers are, for example, applicable to low VOC polyurethane coatings or foams. Likewise, highly polar hydrophilic polymeric products (I) (backbones) may be reacted with at least one alkylene oxide (polymer-filled) which has a low polarity and is hydrophobic (or vice versa) to tailor the surface activity of the alkoxylated polymers. It can therefore be seen that the suitable hydrophilic-hydrophobic combination with suitable molecular weight and glass transition temperature combinations of the polymeric product (I) (backbone) and the alkoxylated side chains will lead to surface active polymers tailored for high selectivity at oil/oil or water/oil interfaces.

Since step (i) is carried out as a high temperature polymerization step it is one further advantage of the process of the present invention that the alkoxylation in step (ii) can be carried out in the same reaction train after or simultaneously with the radical copolymerization for preparing the polymeric product (I) in step (i), thus taking advantage of the low viscosity and high reactivity of the polymeric product (I) at elevated temperatures and thereby minimizing the reaction time and the reaction energy requirements. However, it is also possible to carry out step (i) and step (ii) of the process of the present invention in separate reaction trains, wherein the alkoxylation in step (ii) may be carried out by any suitable process known in the art.

The at least one alkylene oxide employed in step (ii) may be any alkylene oxide known by a person skilled in the art. Examples for suitable alkylene oxides are substituted or unsubstituted alkylene oxides having 2 to 24 carbon atoms, for example, alkylene oxides having halogen, hydroxy, non-cyclic ether or ammonium substituents. The following suitable alkylene oxides are exemplarily mentioned: ethylene oxide, propylene oxide (1,2-epoxy propane), 1,2-methyl-2-methylpropane, butylene oxide (1,2-epoxy butane), 2,3-epoxy butane, 1,2-methyl-3-methylbutane, 1,2-epoxy pentane, 1,2-methyl-3-methylpentane, 1,2-epoxy hexane, 1,2-expoxy heptane, 1,2-expoxy octane, 1,2-epoxy nonane, 1,2-expoxy decane, 1,2-epoxy undecane, 1,2-expoxy dodecane, 1,2-epoxy cyclopentane, 1,2-epoxy cylcohexane (2,3-epoxypropyl)benzene, vinyl oxirane, glycidylether, glycidol, epichlorohydrine, 3-phenoxy-1,2-epoxy propane, 2,3-epoxy methylether, 2,3-epoxy ethylether, 2,3-epoxy isopropylether, 2,3-epoxy-1-propanol, (3,4-epoxybutyl)stearate, 4,5-epoxypentyl acetate, 2,3-epoxy propanemethacrylate, 2,3-epoxy propaneacrylate, glycidylbutylate, methylglycidate, ethyl-2,3-epoxy butanoate, 3-(perfluoromethyl)propane oxide, 3-(perfluoroethyl)propane oxide, 3-(perfluorobutyl)propane oxide, 4-(2,3-epoxypropyl)morpholine, 1-(oxirane-2-ylmethyl)pyrrolidine-2-one, araliphatic alkylene oxide, especially styrene oxide, cyclododecatriene-(1,5,9)-monoxide, and mixtures of two or more thereof.

Preferably, alkylene oxides selected from the group consisting of ethylene oxide, propylene oxide (1,2-epoxy propane), butylene oxide (1,2-butylene oxide, 2,3-butylene oxide or isobutyleneoxide), 1,2-epoxy cyclopentane, 1,2-expoxy cyclohexane, cyclododecatriene-(1,5,9)-monoxide, vinyl oxirane, styrene oxide and mixtures thereof. More preferably, the at least one alkylene oxide of step (ii) is selected from the group consisting of propylene oxide, ethylene oxide, butylene oxide (1,2-butylene oxide, 2,3-butylene oxide or isobutylene oxide), styrene oxide and mixtures thereof. Most preferably, propylene oxide and/or ethylene oxide are used as alkylene oxides in step (ii) of the process of the present invention.

The preparation of the alkylene oxides mentioned before is known in the art. Most of the alkylene oxides mentioned before are commercially available.

In addition, comonomers that will copolymerize with the alkylene oxide in the presence of a catalyst complex can be used. Such comonomers include oxetanes as described in U.S. Pat. No. 3,278,457 and U.S. Pat. No. 3,404,109 and anhydrides (maleic anhydride, succinic anhydride or phthalic anhydride) as described in U.S. Pat. No. 5,145,883 and U.S. Pat. No. 3,538,043, which yield polyethers and polyester or polyetherester sidechains, respectively. Lactones (e.g. ε-caprolactone or γ-butyrolactone) as described in U.S. Pat. No. 5,525,702 and carbon dioxide are examples of other suitable monomers that can be copolymerized with the alkylene oxides as described in U.S. Pat. No. 6,762,278.

The alkoxylation in step (ii) of the present invention may be carried out in the presence or absence of a catalyst. Suitable catalysts are double metal cyanide complex catalysts (DMC-catalysts), amine catalysts such as DMEOA (dimethylethanolamine), tertiary amines, preferably tertiary amines having aliphatic or cycloaliphatic residues, whereby also mixtures of different tertiary amines may be used. Examples are trialkylamines, like trimethylamine, triethylamine, tri-n-propylamine, triisopropylamine, dimethyl-n-propylamine, tri-n-butylamine, triisobutylamine, triisopentylamine, dimethylbutylamine, triamylamine, trioctylhexylamie, dodecyldimethylamine, dimethylcyclohexylamine, dibutylcyclohexylamine, dicyclohexylethylamine, tetramethyl-1,3-butanediamine, as well as tertiary amines having an aliphatic group like dimethylbenzylamine, diethylbenzylamine, α-methyl-benzyldimethylamine. Preferred trialkylamines are trialkylamines having alltogether 6 to 15 carbon atoms like triethylamine, tri-n-propylamine, triisopropylamine, dimethyl-n-propylamine, tri-n-butylamine, triisobutylamine, triisopentylamine, dimethylbutylamine, triamylamine as well as dimethylcyclohexylamine, alkali metal or alkaline earth metal hydroxide catalysts such as sodium hydroxide, potassium hydroxyide or cesium hydroxide, basic catalyst like metal alcanolates, such as metal methanolates, metal ethanolates, metal butanolates, wherein the metal may be sodium, potassium or cesium, or Brönsted-acidic catalyst such as mineral acids like montmorillonite or Lewis acid-catalysts such as boron trifluoride. Besides the soluble basic catalysts, non-soluble basic catalysts such as magnesium hydroxide or hydrotalcite are also suitable. Preferably, the catalyst is selected from the group consisting of a double metal cyanide complex catalyst (DMC-catalyst), an amine catalyst and an alkali metal or alkaline earth metal hydroxide catalyst such as sodium hydroxide or potassium hydroxide. More preferably, the catalyst is a DMC-catalyst, due to the fact that the DMC-catalyst can initiate the alkoxylation reaction in step (ii) in the presence of functional groups which are labile under basic conditions (e.g. ester groups).

Suitable DMC-catalysts are known in the art and, for example, described in WO 2005/113640, US 637673 B1, EP 1 214 368 B1 and DE-A 197 42 978. A particularly preferred class of DMC-catalysts are zinc hexacyano cobaltates.

The DMC catalyst may be preconditioned by methods known by a skilled person. Examples for suitable methods are.
(a) a method wherein the DMC catalyst is preliminary dispersed in a H functional costarter, a small amount of the alkylene oxide is added, followed by heating and polymerization, and thus obtained preliminary activated DMC catalyst dispersion is supplied;
(b) a method wherein the DMC catalyst is dispersed in at least one part of a H functional costarter and supplied to the reactor together with the H functional costarter;
(c) a method wherein a so-called slurried DMC catalyst in a small amount of dispersing medium is supplied;
(d) a method wherein a DMC suspension is formed and dried together with the polymer backbone prior to the alkylene oxide dosing.

Suitable H functional costarters are mentioned below.

At the end of the alkoxylation step (ii), the product mixture obtained may be filtered to remove the DMC catalyst.

The concentration of the catalyst for the alkoxylation step (ii) is selected to polymerize the alkylene oxide at a desired rate or within a desired period of time. Generally, a suitable amount of catalyst is from 10 to 1000 parts by weight metal cyanide catalyst complex per million parts of the product. For determining the amount of catalyst complex to use, the weight of the product is generally considered to equal the combined weight of alkylene oxide and initiator, plus any comonomers that may be used. More preferred catalyst complex levels are from 50 to 500 ppm, especially from 100, to 250 ppm on the same basis.

Additionally, H functional costarters may be used in the alkoxylation in step (ii) of the present invention. Suitable H functional costarters are for example:
a. Monoles,
b. Methanol, butanol, hexanol, heptanol, octanol, decanol, undecanol, dodecanol tridecanol, tetradecanol, pentadecanol, hexadecanol, heptadecanol or octadecanol,
c. Polyoles,
d. Ethylene glycol, propylene glycol, diethylene glycol, dipropylene glycol, glycerin, trimethylol propane, pentaerythrit, sucrose, saccharose, glucose, fructose, mannose, sorbitol, hydroxyalkylated (meth)acrylic acid derivatives as well as alkoxylated derivatives of the H functional costarters mentioned before up to a molecular weight of about 1.500 D,
e. primary and/or secondary amines as well as thioles,
f. unsaturated compounds,
g. compounds comprising OH as well as allylic or vinylic groups, for example allylic alcohol and the etherification products thereof with multivalent alcoholes, like butenol, hexenol, heptenol, octenol, nonenol, decenol, undecenol, vinyl alcohol, allyl alcohol, geraniol, linalool, citronellol, phenol or nonylphenol; preferred alkyl residues are C₄ to C₁₅ alkyl groups,
h. iso-Prenol,
i. Phenoles.

In the case that the polymeric product (I) obtained in step (i) of the process of the present invention comprises COOH functional groups, the alkoxylation according to step (ii) can be performed without the use of a catalyst (autocatalytically). The resulting copolymers exhibit terminal OH groups at the poly(alkylene oxide) side chains obtained in step (ii) which are susceptible for further derivatizations or reactions (e.g. reactions with diisocyanates yielding polyurethanes). It is therefore possible that step (ii), wherein a polymeric product (I) comprising COOH functional groups is employed is carried out firstly without the use of a catalyst (autocatalytically), whereby polymeric products (I) comprising OH-functional groups are formed in situ. Subsequently, the obtained polymeric products (I) comprising OH functional groups may be further reacted with alkylene oxide with use of a catalyst, preferably a catalyst selected from the group of catalysts mentioned before. The advantage of the use of polymeric products (I) comprising COOH functional groups in step (ii) of the process of the present invention is that one can start directly from acrylic acid backbones which are accessible with less raw material costs, since the “pre-synthesis” of hydroxyacrylates from acrylic acid and alkylene oxides is not required anymore.

The alkoxylation in step (ii) of the process of the present invention is usually carried out at a temperature of from 80 to 160° C., preferably 100 to 140° C., more preferably 110 to 130° C.

The process step (ii) may be carried out in the presence of the solvent. Suitable solvents are known by a person skilled in the art and are all liquids which have no hydrogen-active functional groups and which are therefore inert towards the alkoxylation process such as cyclic ethers (e.g. THF, dioxane, trioxane) or glycol diethers such as ethylene glycol dimethylether or ethylene glycoldiethylether or diethylen glykol dimethyl ether or diethylen glycol diethyl ether or esters such as butyl acetate or ketones such as methylamylketone or acetone or aromatic solvents such as benzene, toluene, xylenes, mesitylene and cumene. Also suitable solvents are N,N-dimethylformamide as well as N,N-dimethyacetamide or dimethyl sulfoxide. Preferrably, toluene, tetrahydrofurane or dioxane are used as solvents.

The alkoxylation in step (ii) may be carried out by any process known in the art, for example continuously, batchwise, semi batchwise or by continuous feeding of the starting materials.

In one preferred embodiment step (ii) is carried out by a continuous feed process, wherein one or more of the starting materials are added by a continuous feed process. In one embodiment at least a part of the H functional costarter is continuously added to the reactor during the alkylation step (ii). Optionally, the alkylene oxide may additionally continuously added to the reactor. However, instead of the alkylene oxide, the polymeric backbone may continuously added to the reactor. With respect to the other components which are not continuously added, the process is preferably a semi batch process. The preferred catalyst in said embodiment is a double metal cyanide complex catalyst (DMC-catalyst). Examples for continuous feed processes are described in WO 97/29146 and WO 99/14258.

In a further preferred embodiment the alkoxylation in step (ii) is carried out as continuous process. The alkylene oxide, the polymeric backbone, the catalyst, which may be preferably a double metal cyanide complex catalyst (DMC-catalyst) or an amine catalyst as well as the optionally used H functional costarter are in the case added continuously into the reactor and the desired reaction product is removed continuously. Examples for continuous processes are described in WO 98/03571 and EP 1 469 027.

### Stripping

To remove volatiles, the reaction mixture obtained after the alkylation step (ii) is preferably stripped in a stripping process known by a person skilled in the art. The stripping may be an inert gas, for example nitrogen and/or water vapour stripping which is preferably carried out at a temperature of from 50 to 200° C., preferably 60 to 180° C., more preferably 80 to 160° C. and most preferably 90 to 150° C. The pressure to be applied in the stripping process depends on the circumstances. Preferably, the pressure is at most 1×10⁵ N/m², more preferably at most 0.5×10⁵ N/m² and most preferably at most 0.3×10⁵ N/m². A suitable stripping process is for example described in WO 2005/121214 or DE 103 24 998 A1.

In step (ii) of the process of the present invention, poly(alkylene oxide) side chains on the polymeric product (I) are obtained. Said side chains preferably have a weight average molecular weight of from 50 to 50,000 g/mol, preferably from 100 to 40,000 g/mol and more preferably from 500 to 30.000 to g/mol. This range describes the sum of the molecular weights of the poly(alkylene oxide) side chains, not the molecular weight of one side chain. Each side chain preferably has a weight average molecular weight of from 50 to 5000 g/mol.

The poly(alkylene oxide) side chains obtained in step (ii) of the process of the present invention can be in the form of homopolymers, block copolymers or random copolymers. Homopolymers are in the meaning of the present invention, homopolymeric side chains prepared by one alkylene oxide, whereby suitable alkylene oxides are mentioned before. Preferred homopolymeric side chains are prepared by ethylene oxide or propylene oxide. Block copolymers are in the meaning of the present invention block copolymeric side chains prepared by two or more different alkylene oxides, whereby suitable alkylene oxides are mentioned before. The block copolymers are prepared by adding first one specific alkylene oxide and adding thereafter a further specific alkylene oxide. The block copolymers may comprise two or more different blocks, e.g. AB blocks, wherein the A block is, for example, a polypropylene oxide block and the B block is, for example, a polyethylene oxide block (or vice versa) or ABA blocks, wherein the A block is polypropylene oxide block, the B block is a polyethylene oxide block and the further A block is again a polypropylene oxide block (or vice versa). In this case, the polymeric product (I) is firstly reacted with propylene oxide and thereafter reacted with ethylene oxide (or vice versa) and—in the case of ABA blocks—again reacted with propylene oxide (or vice versa). Random copolymers are in the meaning of the present invention random copolymeric side chains which are obtained by adding a mixture of two or more different alkylene oxides, wherein suitable alkylene oxides are mentioned before, preferably ethylene oxide and propylene oxide, are reacted at the same time with the polymeric product (I). It is also possible that the block copolymeric side chains comprise a block A′ which is a random copolymer and a block B which is a homopolymer.

In one preferred embodiment, the homopolymerization of ethylene oxide or propylene oxide or the copolymerization of propylene oxide and ethylene oxide to form block copolymers is preferred.

In a further embodiment, the present invention concerns an alkoxylated polymer obtained by a process according to the present invention. Preferred monomers employed for the preparation of the polymeric product (I) (backbone) as well as preferred alkylene oxides or mixtures thereof employed for the preparation of the poly(alkylene oxide) side chains of the alkoxylated polymer are mentioned before. The alkoxylated polymers comprise a very homogeneous microstructure with a homogeneous distribution of the poly(alkylene oxide) side chains along the polymeric product (I) (backbone). Further, the alkoxylated polymers of the present invention comprise a narrow composition distribution as well as a narrow molecular weight distribution (polydispersity M_{w}/Mₙ), which is—especially in the case of alkoxylated polymers starting from polymers having an OH functional backbone—in general at most 4.5, preferably 1.2 to 4.0, more preferably 1.4 to 3.7. However, depending on the application of the alkoxylated polymer, it is also possible to prepare alkoxylated polymers having a broader molecular weight distribution.

The weight average molecular weight of the alkoxylated polymers according to the present invention can also be tailored depending on the application of the alkoxylated polymers. The weight average molecular weight of the alkoxylated polymer is in general in the range of from 1000 to 75,000 g/mol, preferably in the range of from 1500 to 50,000 g/mol.

The alkoxylated polymer of the present invention has in general a OH value of from 5 to 400 mg KOH/g, preferably from 20 to 300 mg KOH/g. The acid value is in general of from 10 to 0.001 mg KOH/g, preferably from 1 to 0.01 mg KOH/g. The OH value depends on the functional backbones (COOH or OH) of the polymer used as starting material.

If the alkoxylated polymer obtained is a liquid polymer, the viscosity at 25° C. is generally in the range of from 500 to 50.000 mPas, preferably 1000 to 20.000 mPas.

The molecular weights mentioned in the present application are average molecular weights, and the molecular weights and the polydispersity are determined by SEC methods, using a polystyrene matrix as a reference. The viscosity (25° C.) is determined according to DIN 51 550. The OH value is determined according to DIN 53240′ and the acid value is determined according to DIN EN ISO 3682.

According to the invention, it is additionally possible to add one or more stabilizers to the reaction mixture or to one of the components before or after the alkylation step (ii) or during or after stripping, if a stripping is carried out. Said stabilizer can prevent the formation of undesired byproducts due to oxidation processes.

In the present invention, all stabilizers known to a person skilled in the art can in principle be used. These components include for example antioxidants, synergistic agents and metal deactivators.

Antioxidants used are, for example, sterically hindered phenols and aromatic amines.

Examples of suitable phenols are alkylated monophenols, such as 2,6-di-tert-butyl-4-methylphenol (BHT), 2-butyl-4,6-dimethylphenol, 2,6-di-tert-butyl-4-methoxyphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tertbutyl-4-methoxymethylphenol, linear nonylphenols or nonylphenols branched in the side chain, such as 2,6-dinonyl-4-methylphenol, 2,4-dimethyl-6-(1′-methyl-undec-1-yl)phenol, 2,4-dimethyl-6-(1′-methyl-heptadec-1-yl)phenol, 2,4-dimethyl-6-(1′-methyltridec-1′-yl)phenol and mixtures thereof;

alkylthiomethylphenols, such as 2,4-dioctylthiomethyl-6-tert-butylphenol, 2,4-dioctylthiomethyl-6-methylphenol, 2,4-dioctylthiomethyl-6-ethylphenol, octyl(3,5-di-tertbutyl-4-hydroxyphenyl)propionate (Irganox I1135) or 2,6-didodecylthiomethyl-4-nonylphenol;
tocopherols, such as α-tocopherol, β-tocopherol, γ-tocopherol, δ-tocopherol and mixtures thereof;
hydroxylated thiodiphenyl ethers, such as 2,2′-thiobis(6-tert-butyl-4-methylphenol), 2,2′-thiobis(4-octylphenol), 4,4′-thio-bis(6-tert-butyl-3-methylphenol), 4,4′-thiobis(6-tert-butyl-2-methylphenol), 4,4′-thiobis(3,6-di-sec-amylphenol), thiodiphenylamine(phenothiazine), or 4,4′-bis(2,6-dimethyl-4-hydroxyphenyl)disulfide;
alkylidenebisphenols, such as 2,2′-methylenebis(6-tert-butyl-4-methylphenol), 2,2′-methylenebis(6-tert-butyl-4-ethylphenol), 2,2′-methylenebis(6-tert-butyl-4-butylphenol), 2,2′-methylenebis[4-methyl-6-(α-methylcyclohexyl)phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 1,1-bis(5-tert-butyl-4-hydroxy-2-methylphenyl)butane, 2,6-bis(3-tert-butyl-5-methyl-2-hydroxybenzyl)4-methylphenol, 1,1,3-tris(5-tert-butyl-4-hydroxy-2-methylphenyl)butane, 1,1-bis(5-tert-butyl-4-hydroxy-2-methylphenyl)-3-n-dodecylmercaptobutane, ethylene glycol bis[3,3-bis(3′-tert-butyl-4′-hydroxyphenyl)butyrate, bis(3-tert-butyl-4-hydroxy-5-methylphenyl)dicyclopentadiene, 1,1-bis(3,5-dimethyl-2-hydroxyphenyl)butane, 2,2-bis(3,5-di-tert-butyl-4-hydroxyphenyl)propane, 2,2-bis(3,5-di-tert-butyl-4-hydroxy-2-methylphenyl)-4-n-dodecylmercaptobutane or 1,1,5,5-tetra(5-tert-butyl-4-hydroxy-2-methylphenyl)pentane;
and other phenols, such as methyl(3,5-di-tert-butyl-4-hydroxyphenyl)propionate (PS40), octadecyl(3,5-di-tert-butyl-4-hydroxyphenyl)propionate (Irganox I1076), N,N′-hexamethylenebis(3,5-di-tert-butyl-4-hydroxyhydrocinnamide), tetrakis[methylene(3,5-di-tert-butyl-4-hydroxyhydrocinnamoyl)]methane, 2,2′-oxamidobis[ethyl-3(3,5-di-tertbutyl-4-hydroxyphenyl)]propionate or tris-(3,5-di-tert-butyl-4-hydroxybenzyl)isocyanurate.

Examples of suitable amines are 2,2,6,6-tetramethylpiperidine, N-methyl-2,2,6,6-tetramethylpiperidine, 4-hydroxy-2,2,6,6-tetramethylpiperidine, bis(2,2,6,6-tetramethyl-4-piperidyl)sebacate, bis(N-methyl-2,2,6,6-tetramethyl-4-piperidyl)sebacate, butylated and octylated diphenylamines (Irganox I5057 and PS30), N-allyldiphenylamine, 4-isopropoxydiphenylamine, N-phenyl-1-naphthylamine, N-phenyl-2-naphthylamine, 4-dimethylbenzyldiphenylamine, etc.

Synergistic agents include, for example, compounds from the group consisting of the phosphites, phosphonites and hydroxylamines, for example triphenyl phosphite, diphenyl alkyl phosphites, phenyl dialkyl phosphites, tris(nonylphenyl)phosphite, trilauryl phosphite, trioctadecyl phosphite, tris(2,4-di-tert-butylphenyl)phosphite, diisodecyl pentaerythrityl diphosphite, bis(2,4-di-tert-butylphenyl)pentaerythrityl diphosphite, bis(2,6-di-tert-butyl-4-methylphenyl)pentaerythrityl diphosphite, bisisodecyloxypentaerythrityl diphosphite, bis(2,4-di-tert-butyl-6-methylphenyl)pentaerythrityl diphosphite, bis(2,4,6-tri-tert-butylphenyl)pentaerythrityl diphosphite, tristearyl sorbitol trisphosphite, tetrakis(2,4-di-tert-phenyl) 4,4′-biphenylene diphosphite, 6-isooctyloxy-2,4,8,10-tetratert-butyl-12H-dibenzo[d,g]-1,3,2-dioxaphosphocin, 6-fluoro-2,4,8,10-tetra-tert-butyl-12-methyl-dibenzo[d,g]-1,3,2-dioxaphosphocin, bis(2,4-di-tert-butyl-6-methylphenyl)methylphosphite, bis(2,4-di-tert-butyl-6-methylphenyl)ethylphosphite, N,N-dibenzylhydroxylamine, N,N-diethylhydroxylamine, N,N-dioctylhydroxylamine, N,N-dilauylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine or N,N-dialkylhydroxylamine from hydrogenated tallow fatty amines;

metal deactivators are, for example, N′-diphenyloxalamide, N-salicylal-N′-salicyloylhydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalic acid dihydrazide, oxanilide, isophthalic acid dihydrazide, sebacic acid bisphenylhydrazide, N,N′-diacetyladipic acid dihydrazide, N,N′-bissalicyloyloxalic acid dihydrazide and N,N′-bissalicyloylthiopropionic acid dihydrazide.

Stabilizers preferred according to the invention are 2,6-di-tert-butyl-4-methylphenol (BHT), octyl(3,5-di-tert-butyl-4-hydroxyphenyl)propionate (Irganox I1135), thiodiphenylamine(phenothiazine), methyl(3,5-di-tert-butyl-4-hydroxyphenyl)propionate (PS40), octadecyl(3,5-di-tert-butyl-4-hydroxyphenyl)propionate (Irganox I1076) and butylated and octylated diphenylamines (Irganox I5057 and PS30).

The alkoxylated polymers of the present invention can in one embodiment be used for preparing polyurethanes, for example, in the form of rigid or flexible foams, elastomers, coatings, sealants, adhesives, embedding compositions or crosslinkers. The polyurethanes can be produced by methods known in the art, for example by reacting the alkoxylated polymers of the present invention with isocyanates or polyisocyanates, preferably diisocyanates, as described, for example, in Kunststoff-Handbuch, Vol. VII, “Polyurethane”, 3^{rd} edition, 1993, edited by Dr. G. Oertel (Carl Hanser Verlag Munich). Depending on the desired properties of the polyurethanes, it is possible to use the alkoxylated polymers of the present invention either alone or together with other compounds having at least two hydrogen atoms which are reactive toward isocyanate groups. As compounds which have at least two hydrogen atoms which are reactive toward isocyanate groups and can be used together with the alkoxylated polymers according to the present invention for the reaction with polyisocyanates, polyester alcohols, and polyether alcohols, and, optionally, bifunctional or polyfunctional alcohols and amines, known as chain extenders and crosslinkers are included. It is also possible to use catalysts, blowing agents and customary auxiliaries and/or additives.

In a further embodiment, the present invention therefore relates to a process for preparing polyurethanes by reaction of the alkoxylated polymer according to the present invention with isocyanates or polyisocyanates as well as to polyurethanes prepared by the process mentioned before. Suitable embodiments of the process as well as suitable isocyanates and polyisocyanates are mentioned in the literature mentioned before. Further, suitable further components which may be used in the preparation of the polyurethanes according to the present invention are mentioned before.

The alkoxylated polymers of the present invention are not only suitable for the preparation of polyurethanes. The following reactions of the alkoxylated polymers are also included by the present invention:
i) Reaction of the terminal OH groups of the alkoxylated polymers with diisocyanates or monoisocyanates not to prepare polyurethanes therefrom but to introduce additional side chains, for example fatty alcohols or other blocks or functionalites;
ii) Esterification of the terminal OH groups of the alkoxylated polymers with carboxylic acids or derivatives thereof, for example fatty acids, acrylic acids and/or methacrylic acids, to introduce polymerizable functional groups;
iii) Etherification of the terminal OH groups of the alkoxylated polymers, for example via allylation, vinylation or alkylation;
iv) Sulfonation and/or phosphonation terminal OH groups of the alkoxylated polymers to introduce ionic functional groups.

Furthermore, beside the use of the alkoxylated polymers of the present invention for preparing polyurethanes, the alkoxylated polymer according to the present invention can be used as steric stabilizers for polymer-filled polyols, as non-ionic surfactants, as electrosteric surfactants, as protective colloids, as superabsorbers, as dispersants, especially as waterborne and solventborne pigment and mineral dispersants, as surface modification agents, especially as surface modification agents for coatings and plastics, as plastics modifiers, as concrete plasticizers or further traditional uses of surface active reagents. Additionally, the alkoxylated polymers according to the present invention may be used in detergent formulations.

The present invention therefore relates in a further embodiment to a surface active reagent comprising or consisting of at least one alkoxylated polymer according to the present invention. Preferably, the surface active reagent is selected from the group consisting of steric stabilizers for polymer-filled polyols, non-ionic surfactants, eletrosteric surfactants, protective colloids, superabsorbers, dispersants, surface modification agents, plastics modifiers and concrete plasticizers.

In a further embodiment, the present invention relates to detergent formulations comprising at least one alkoxylated polymer according to the present invention. Suitable further components of the detergent formulation are known by a person skilled in the art.

The invention is illustrated by the following examples:

### EXAMPLE 1

### Preparation of Solid OH Functional Backbones

Fourteen (14) different OH Functional Backbones, were designed and prepared in a 2 gal free radical continuous polymerization reactor system according to the teachings of the U.S. Pat. No. 5,508,366 (columns 6 through 9). The specific synthesis conditions and polymer characterization parameters are given in Table 1 below.

TABLE 1
Solid OH Functional Backbones

| | Example | Example | Example | Example | Example | Example | Example | Example |
|---|---|---|---|---|---|---|---|---|
| Characteristics/ID | 1-1 | 1-2 | 1-3 | 1-4 | 1-5 | 1-6 | 1-7 | 1-8 |
| REACTOR FEED COMPOSITION | | | | | | | | |
| Styrene (S) (wt. %) | 30 | 30 | 30 | 55 | 55 | 55 | 55 | 55 |
| Methyl Methacrylate | 25 | 25 | 25 | — | — | — | — | — |
| (MMA) (wt. %) | | | | | | | | |
| Hydroxyethyl Methacrylate | 20 | 20 | 20 | 20 | 20 | 20 | 20 | 20 |
| (HEMA) (wt. %) | | | | | | | | |
| Hydroxyethyl Acrylate | 15 | 15 | 15 | 15 | 15 | 15 | 15 | 15 |
| (HEA) (wt. %) | | | | | | | | |
| Di-tertbutyl Perxyde | 0.3 | 0.3 | 0.3 | 0.3 | 0.3 | 0.3 | 1.0 | 1.0 |
| (wt. %) | | | | | | | | |
| Isopropanol (wt. %) | 9.7 | 9.7 | 9.7 | 9.7 | 9.7 | 9.7 | 9.0 | 9.0 |
| REACTION CONDITIONS | | | | | | | | |
| Reactor Temperature (° C.) | 204 | 193 | 188 | 193 | 207 | 204 | 193 | 204 |
| Residence Time (minutes) | 12 | 12 | 12 | 12 | 12 | 12 | 12 | 12 |
| BACKBONE CHARACTERISTICS | | | | | | | | |
| Mn | 3,530 | 4,719 | 5,183 | 6,215 | 4,333 | 5,072 | 4,222 | 3,235 |
| Mw | 9,317 | 13,051 | 15,546 | 20,870 | 12,954 | 14,818 | 11,975 | 8,351 |
| Mw/Mn | 2.64 | 2.77 | 3.00 | 3.36 | 2.99 | 2.92 | 2.84 | 2.58 |
| Fn (OH groups/chain) | 11.1 | 14.9 | 16.4 | 19.6 | 13.7 | 16.0 | 13.3 | 10.2 |
| OH # | 185 | 185 | 185 | 185 | 185 | 185 | 185 | 185 |
| Polarity (% O2 w/w) | 24.0 | 24.0 | 24.0 | 15.0 | 15.0 | 15.0 | 15.0 | 15.0 |
| Tg (midpoint ° C.) | 55 | 60 | 64 | 63 | 69 | 68 | 69 | 65 |

| | Example | Example | Example | Example | Example | Example |
|---|---|---|---|---|---|---|
| Characteristics/ID | 1-9 | 1-10 | 1-11 | 1-12 | 1-13 | 1-14 |
| REACTOR FEED COMPOSITION | | | | | | |
| Styrene (S) (wt. %) | 30 | 30 | 30 | 55 | 55 | 55 |
| Methyl Methacrylate | 40 | 40 | 40 | 15 | 15 | 15 |
| (MMA) (wt. %) | | | | | | |
| Hydroxyethyl Methacrylate | 5 | 5 | 5 | 5 | 5 | 5 |
| (HEMA) (wt. %) | | | | | | |
| Hydroxyethyl Acrylate | 15 | 15 | 15 | 15 | 15 | 15 |
| (HEA) (wt. %) | | | | | | |
| Di-tertbutyl Peroxide | 0.3 | 0.3 | 0.3 | 0.3 | 0.3 | 0.3 |
| (wt. %) | | | | | | |
| Isopropanol (wt. %) | 9.7 | 9.7 | 9.7 | 9.7 | 9.7 | 9.7 |
| REACTION CONDITIONS | | | | | | |
| Reactor Temperature (° C.) | 188 | 196 | 204 | 190 | 196 | 204 |
| Residence Time (minutes) | 12 | 12 | 12 | 12 | 12 | 12 |
| BACKBONE CHARACTERISTICS | | | | | | |
| Mn | 5,080 | 4,308 | 3,402 | 6,496 | 5,612 | 4,738 |
| Mw | 16,264 | 12,694 | 9,394 | 22,891 | 19,403 | 14,702 |
| Mw/Mn | 3.20 | 2.95 | 2.76 | 3.52 | 3.46 | 3.10 |
| Fn (OH groups/chain) | 9.4 | 8.0 | 6.3 | 12.0 | 10.4 | 8.7 |
| OH # | 110 | 110 | 110 | 110 | 110 | 110 |
| Polarity (% O2) | 24.0 | 24.0 | 24.0 | 15.0 | 15.0 | 15.0 |
| Tg (midpoint ° C.) | 66 | 63 | 57 | 71 | 66 | 65 |

The molecular weights mentioned are average molecular weights and the molecular weights and the polydispersity are determined by SEC methods, using a polystyrene matrix as a reference. The OH value is determined according to DIN 53240′. Tg is determined according to ISO 11357-2:1999. Fn, OH# and Polarity are based on stoichiometric computations from monomer feed composition and Mn.

### EXAMPLE 2

### Preparation of Liquid OH Functional Backbones

Six (6) different OH Functional Backbones were designed and prepared in a 2 gal free radical continuous polymerization reactor system according to the teachings of the U.S. Pat. No. 5,508,366 (columns 6 through 9). The specific synthesis conditions and polymer characterization parameters are given in Table 2 below.

TABLE 2
Liquid OH Functional Backbones

| Characteristics/ID | Example 2-1 | Example 2-2 | Example 2-3 | Example 2-4 | Example 2-5 | Example 2-6 |
|---|---|---|---|---|---|---|
| REACTOR FEED COMPOSITION | | | | | | |
| Butyl Acrylate (BA) (% w) | 49 | 49 | 49 | — | — | — |
| 2-Ethyl Hexyl Acrylate (2-EHA %) | — | — | — | 49 | 49 | 49 |
| Hydroxyethyl Acrylate (HEA) (wt. %) | 31 | 31 | 31 | 31 | 31 | 31 |
| Di-tertbutyl Perxyde (wt. %) | 2 | 2 | 2 | 2 | 2 | 2 |
| Isopropanol (wt. %) | 18 | 18 | 18 | 18 | 18 | 18 |
| REACTION CONDITIONS | | | | | | |
| Reactor Temperature (° C.) | 204 | 210 | 193 | 193 | 204 | 210 |
| Residence Time (minutes) | 12 | 12 | 12 | 12 | 12 | 12 |
| Mn | 1,274 | 1,209 | 1,419 | 1,349 | 1,221 | 1,165 |
| Mw | 2,021 | 1,889 | 2,330 | 2,067 | 1,853 | 1,730 |
| Mw/Mn | 1.59 | 1.56 | 1.64 | 1.53 | 1.50 | 1.48 |
| Fn (OH groups/chain) | 4.3 | 4.1 | 4.8 | 4.5 | 4.1 | 3.9 |
| OH # | 185 | 185 | 185 | 185 | 185 | 185 |
| Polarity (% O2) | 31.5 | 31.5 | 31.5 | 27.0 | 27.0 | 27.0 |
| Viscosity (Brookfield#4@25° C.) (mPa/s) | 32,000 | 27,050 | 52,900 | 34,250 | 22,200 | 9,980 |

The molecular weights mentioned are average molecular weights and the molecular weights and the polydispersity are determined by SEC methods, using a polystyrene matrix as a reference. The OH value is determined according to DIN 53240′. Tg is determined according to ISO 11357-2:1999. Fn, OH# and Polarity are based on stoichiometric computations from monomer feed composition and Mn.

### EXAMPLE 3

### Preparation of Solid COOH Functional Backbones

Three (3) different COOH Functional Backbones were designed and prepared in a 2 gal free radical continuous polymerization reactor system according to the teachings of the U.S. Pat. No. 4,546,160 (columns 5 through 11). The specific synthesis conditions and polymer characterization parameters are given in Table 3 below.

TABLE 3
Solid COOH Functional Backbones

| Characteristics/ID | Example 3-1 | Example 3-2 | Example 3-3 |
|---|---|---|---|
| REACTOR FEED | | | |
| COMPOSITION | | | |
| Styrene (S) (wt. %) | 20 | 20 | 20 |
| Methyl Methacrylate | 40 | 40 | 40 |
| (MMA) (wt. %) | | | |
| Acrylic Acid (AA) (wt. %) | 30 | 30 | 30 |
| Di-tertbutyl Perxyde (wt. %) | 0.2 | 1.0 | 0.5 |
| Acetone (wt. %) | 9.8 | 9.0 | 9.5 |
| REACTION CONDITIONS | | | |
| Reactor Temperature (° C.) | 209 | 216 | 216 |
| Residence Time (minutes) | 12 | 12 | 12 |
| BACKBONE | | | |
| CHARACTERISTICS | | | |
| Mn | 3,213 | 1,757 | 2,043 |
| Mw | 9,176 | 3,683 | 4,657 |
| Mw/Mn | 2.86 | 2.10 | 2.28 |
| Fn (COOH groups/chain) | 14.7 | 8.0 | 9.3 |
| Acid # | 233.3 | 231.4 | 231.8 |
| Polarity (% O2) | 29.0 | 29.0 | 29.0 |
| Tg (midpoint ° C.) | 95.4 | 83.0 | 85.0 |

The molecular weights mentioned are average molecular weights and the molecular weights and the polydispersity are determined by SEC methods, using a polystyrene matrix as a reference. The OH value is determined according to DIN 53240′. Tg is determined according to ISO 11357-2:1999. Fn and Polarity are based on stoichiometric computations from monomer feed composition and Mn. The acid value is determined according to ISO 2114:2000.

### EXAMPLE 4

### Preparation of Liquid COOH Functional Backbones

Six (6) different COOH Functional Backbones were designed and prepared in a 2 gal free radical continuous polymerization reactor system according to the teachings of the U.S. Pat. No. 4,546,160 (columns 5 through 11). The specific synthesis conditions and polymer characterization parameters are given in Table 4 below.

TABLE 4
Liquid COOH Functional Backbones

| Characteristics/ID | Example 4-1 | Example 4-2 | Example 4-3 | Example 4-4 | Example 4-5 |
|---|---|---|---|---|---|
| REACTOR FEED | | | | | |
| COMPOSITION | | | | | |
| Butyl Acrylate (BA) (% w) | 58 | 58 | — | 35 | 35.0 |
| 2-Ethylhexyl Acrylate | — | — | 58 | 23 | 23.0 |
| (2-EHA) | | | | | |
| Acrylic Acid (AA) (% w) | 32 | 32 | 32 | 27 | 27.0 |
| Di-tertbutyl Peroxyde | 2 | 2 | 2 | 2 | 2 |
| (wt. %) | | | | | |
| Acetone (wt. %) | 8 | 8 | 8 | 13 | 13 |
| REACTION CONDITIONS | | | | | |
| Reactor Temperature (° C.) | 216 | 210 | 208 | 224 | 212 |
| Residence Time (minutes) | 12 | 12 | 12 | 12 | 12 |
| BACKBONE | | | | | |
| CHARACTERISTICS | | | | | |
| Mn | 1,736 | 1,867 | 1,858 | 1,401 | 1,554 |
| Mw | 3,567 | 4,002 | 3,815 | 2,435 | 2,815 |
| Mw/Mn | 2.05 | 2.14 | 2.05 | 1.74 | 1.81 |
| Fn (COOH groups/chain) | 8.4 | 9.1 | 9.0 | 6.3 | 6.9 |
| Acid # | 226 | 229 | 227 | 187 | 195 |
| Polarity (% O2) | 31.5 | 31.5 | 26.5 | 29.0 | 29.0 |
| Tg (midpoint ° C.) | 6.3 | 9.2 | 2.8 | 4.5 | 5.0 |

The molecular weights mentioned are average molecular weights and the molecular weights and the polydispersity are determined by SEC methods, using a polystyrene matrix as a reference. The OH value is determined according to DIN 53240′. Tg is determined according to ISO 11357-2:1999. Fn and Polarity are based on stoichiometric computations from monomer feed composition and Mn. The acid value is determined according to ISO 2114:2000.

### EXAMPLE 5

### Propoxylation of a solid OH Functional Backbone

A solution of the copolymer backbone from example 1-1 (50.0 g) in 50 mL dry toluene and a zinc hexacyano cobaltate double metal cyanide complex catalyst (170 mg suspended in PPG 2000) were added to a 300 mL stainless steel reactor and heated to 130° C. The mixture was evacuated three times to remove the oxygen from the reaction mixture. After that, propylene oxide (20.0 g) was added to initiate the catalyst. After activation, the propylene oxide dosing was continued for 60 min at a dosing speed of 2.5 mL/min. The product was kept at 130° C. for 30 min after alkylene oxide addition was completed and then the mixture was subjected to vacuum for 30 min to remove the solvent yielding a hybrid copolymer with the following analytical data:

OH value: 21.0 mg KOH/g
Acid value: 0.03 mg KOH/g

### M_{w}: 31482

### Mₙ: 8856

### Polydispersity: 3.6

### EXAMPLE 6

### Propoxylation of a Liquid OH Functional Backbone

The copolymer backbone from example 2-2 (100 g) and a zinc hexacyano cobaltate double metal cyanide complex catalyst (120 mg suspended in PPG 2000) were added to a 300 mL stainless steel reactor. The mixture was evacuated at 130° C. for 1 h to remove residual water. Propylene oxide (20 g) was then added at 130° C. to the reaction mixture at a dosing rate of 2.5 mL/min. After addition of the alkylene oxide the product was kept at 130° C. for additional 30 min to ensure complete conversion. After the reaction was completed the product was then vacuum-stripped for 30 min yielding a hybrid copolymer with the following analytical data:

| | | |
|---|---|---|
| Hydroxy Value | 92.1 | mg KOH/g |
| Viscosity (25° C.) | 8543 | mPa · s |

| | |
|---|---|
| M_{w} | 1703 |
| Mₙ | 1006 |
| Polydispersity | 1.69 |

### EXAMPLE 7

### Propoxylation of a Solid COOH Functional Backbone

A solution of the copolymer backbone from example 3-1 (50.0 g) in 50 mL of dioxane and a zinc hexacyano cobaltate double metal cyanide complex catalyst (195 mg suspended in PPG 2000) were added to a 300 mL stainless steel reactor and heated to 130° C. The mixture was evacuated three times to remove the oxygen from the reaction mixture. After that, propylene oxide (58.2 g) was added with a dosing speed of 2.5 mL/min. After the reaction was completed, which was indicated by a constant pressure, the reaction mixture was subjected to vacuum to remove the solvent yielding a highly viscous hybrid copolymer with the following analytical data:

| | | |
|---|---|---|
| Hydroxy Value | 102.1 | mg KOH/g |

| | |
|---|---|
| M_{w}: | 27828 |
| Mₙ: | 2627 |
| Polydispersity: | 10.6 |

### EXAMPLE 8

### Propoxylation of a Liquid COOH Functional Backbone

The copolymer backbone from example 4-3 (57.6 g) and a zinc hexacyano cobaltate double metal cyanide complex catalyst (195 mg suspended in PPG 2000) were added to a 300 mL stainless steel reactor. The mixture was evacuated for 130° C. for 1 h. Propylene oxide (11.5 g) was added to initiate the catalyst. After activation, propylene oxide dosing was continued for 18 min at a dosing rate of 2.5 mL/min). The product was heated to 130° C. after alkylene oxide addition and then vacuum stripped for 30 min yielding a viscous hybrid copolymer with the following analytical data:

| | | |
|---|---|---|
| Hydroxy Value | 57.4 | mg KOH/g |
| Acid Value | 28.7 | mg KOH/g |
| Viscosity | 11876 | mPas |

| | |
|---|---|
| M_{w} | 36550 |
| Mₙ | 2340 |
| Polydispersity | 15.6 |

### EXAMPLE 9

### Propoxylation of a Liquid COOH Functional Backbone without the Presence of an Alkoxylation Catalyst

The copolymer backbone from example 4-3 (103.7 g) was added to a 300 mL stainless steel reactor. The polymer was evacuated for 130° C. for 1 h. Propylene oxide (53.6 g) was continuously added to over a period of 12 h at a dosing rate of 2.5 mL/min). The product was heated to 130° C. after alkylene oxide addition and then vacuum stripped for 30 min yielding a viscous hybrid copolymer with the following analytical data:

| | | |
|---|---|---|
| Hydroxy Value | 144.6 | mg KOH/g |
| Acid Value | 8.3 | mg KOH/g |
| Viscosity (75° C.) | 2838 | mPas |

| | |
|---|---|
| M_{w} | 10877 |
| Mₙ | 2619 |
| Polydispersity | 4.2 |

### EXAMPLE 10

### Ethoxylation of a Liquid OH Functional Backbone

The copolymer backbone from example 2-6 (50 g) and a zinc hexacyano cobaltate double metal cyanide complex catalyst (230 mg suspended in PPG 2000) were added to a 300 mL stainless steel reactor. The mixture was evacuated at 130° C. for 1 h to remove residual water. Ethylene oxide (73.7 g) was then added at 130° C. to the reaction mixture at a dosing rate of 2.5 mL/min. After addition of the ethylene oxide the product was kept at 130° C. for additional 30 min to ensure complete conversion. After the reaction was completed the product was then vacuum-stripped for 30 min yielding a solid hybrid copolymer at room temperature with the following analytical data:

| | | |
|---|---|---|
| Hydroxy Value | 73.4 | mg KOH/g |

| | |
|---|---|
| M_{w} | 5701 |
| Mₙ | 1878 |
| Polydispersity | 3.03 |

1. A process for preparing an alkoxylated polymer, the process comprising:
(i) preparing a polymeric product (I) having at least one functional group by radical copolymerization of the following monomers
(a) at least one functionalized acrylic monomer (a),
(b) at least one additional monoethylenically unsaturated free radical polymerizable monomer (b), and
(c) optionally at least one multiethylenically unsaturated free radical polymerizable monomer (c),
at temperatures between 150 and 350° C.; and
(ii) contacting the polymeric product (I) with at least one alkylene oxide.

2. The process of claim 1, wherein the polymeric product (I) has a weight average molecular M_{w} of from 1,000 to 30,000 g/mol.

3. The process of claim 1, wherein the following monomers (a), (b) and optionally (c) are radically copolymerized:
(a) at least one functionalized acrylic monomer (a) selected from the group consisting of an OH-functional acrylic monomer (a1), a COOH-functional acrylic monomer (a2), a cyclic anhydride monomer (a3), an epoxy-functional acrylic monomer (a4) and mixtures thereof;
(b) at least one additional monoethylenically unsaturated free radical polymerizable monomer (b) comprising at least one group selected from the group consisting of
(b1) an ester of an α,β-monoethylenically unsaturated monocarboxylic acid (b1) or an ester of an α,β-monoethylenically unsaturated dicarboxylic acid (b1), having 3 to 6 carbon atoms with alkanols having 1 to 20 carbon atoms,
(b2) a vinyl aromatic monomer (b2),
(b3) an ester (b3) of a vinyl alcohol and a monocarboxylic acid having from 1 to 18 carbon atoms,
(b4) an olefin (b4),
(b5) a nitrile (b5) of a α,β-monoethylenically unsaturated monocarboxylic acid having 1 to 18 carbon atoms, and mixtures thereof; and
(c) optionally at least one multiethylenically unsaturated free radical polymerizable monomer (c) comprising at least two non-conjugated double bonds selected from the group consisting of an alkylene glycol diacrylate, an alkylene glycol dimethacrylate, a divinyl benzene, a vinyl methacrylate, a vinyl acrylate, allyl methacrylate, allyl acrylate, diallyl maleate, diallyl fumarate, methylene bisacrylic amide, cyclopentadianyl acrylate, triallyl cyanurate, triallyl isocyanurate, diacetone acrylic amide, acetylacetoxyethyl acrylate and acetylacetoxyethyl methacrylate.

4. The process of claim 1, wherein the following monomers are radically copolymerized in the following proportions
(a) 5 to 70% by weight of the at least one monomer (a),
(b) 30 to 95% by weight of the at least one monomer (b), and
(c) 0 to 15% by weight of the at least one monomer (c),
wherein the sum of components (a), (b) and optionally (c) is 100% by weight.

5. The process of claim 4, wherein the following monomers are radically copolymerized in the following proportions
(a) 10 to 65% by weight of the at least one monomer (a),
(b) 35 to 90% by weight of the at least one monomer (b), and
(c) 0.1 to 12% by weight of the at least one monomer (c),
wherein the sum of the components (a), (b) and optionally (c) is 100% by weight.

6. The process of claim 1, wherein the polymeric product (I) is a perfectly statistical copolymer.

7. The process of claim 1, wherein the polymeric product (I) has a molecular weight distribution M_{w}/Mₙ of at most 4.0.

8. The process of claim 1, wherein the at least one alkylene oxide is selected from the group consisting of propylene oxide, ethylene oxide, butylene oxide, styrene oxide and mixtures thereof.

9. The process of claim 1, wherein the radical copolymerization (ii) occurs in the presence of a catalyst.

10. The process of claim 9, wherein the catalyst is a double metal cyanide complex catalyst.

11. An alkoxylated polymer obtained by the process of claim 1.

12. The alkoxylated polymer of claim 11 comprising at least one poly(alkylene oxide) side chain, wherein a weight average molecular weight of the sum of the molecular weights of the side chains of the at least one poly(alkylene oxide) side chains is from 50 to 50,000 g/mol.

13. A process for preparing a polyurethane, the process comprising reacting the alkoxylated polymer of claim 11 with at least one isocyanate or polyisocyanate.

14. A polyurethane prepared by the process of claim 13.

15. A surface active reagent, comprising at least one alkoxylated polymer of claim 11.

16. The surface active reagent of claim 15, wherein the surface active reagent is at least one selected from the group consisting of a steric stabilizer for polymer-filled polyols, a non-ionic surfactant, an electrosteric surfactant, a protective colloid, a superabsorber, a dispersant, a surface modification agent, a plastic modifier and a concrete plasticizer.

17. A detergent formulation, comprising at least one alkoxylated polymer of claim 11.

18. A surface active reagent, consisting of at least one alkoxylated polymer of claim 11.

19. The surface active reagent of claim 18, wherein the surface active reagent is at least one selected from the group consisting of a steric stabilizer for polymer-filled polyols, a non-ionic surfactant, an electrosteric surfactant, a protective colloid, a superabsorber, a dispersant, a surface modification agent, a plastic modifier and a concrete plasticizer.
